(19) United States
(12) Patent Application Publication
(10) Pub. No.: US 2010/0180441 A1
(43) Pub. Date: Jul. 22, 2010

(54) Method of brazing heat sink

(75) Inventors: Kenji Otsuka, Okazaki-shi (JP); Masaru Nakashima, Toyota-shi (JP); Yoshiki Tomita, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/591,929

(22) Filed: Dec. 4, 2009

(30) Foreign Application Priority Data
Jan. 20, 2009 (JP) 2009-009482

(51) Int. Cl. B23P 15/26

(52) U.S. Cl. 29/890.054

(57) ABSTRACT

A method of brazing a heat sink includes: fitting at least a part of a bottom plate between protruding opposite ends of a top plate; fixing a jig to an outer periphery of the top plate in order to prevent the top plate that thermally expands from extending outward in a width direction of the top plate; and braze-bonding an inner side surface of the top plate to a side surface of the bottom plate, which faces the inner side surface of the top plate.

### INCORPORATION BY REFERENCE

The disclosure of Japanese Patent Application No. 2009-009482 filed on Jan. 20, 2009 including the specification, drawings and abstract is incorporated herein by reference in its entirety.

### BACKGROUND OF THE INVENTION

1. Field of the Invention

The present invention relates to a method of brazing a heat sink.

2. Description of the Related Art

Conventionally, insulated gate bipolar transistor (IGBT) semiconductor power modules use a heat sink that efficiently dissipates heat generated by the semiconductor chip to maintain the semiconductor chip at or below a predetermined temperature.

The general structure of a typical heat sink is described with reference to FIG. 1. A heat sink 110 is formed of a lightweight material having suitable thermal conductivity, for example, aluminum. The heat sink 110 comprises a top plate 114 and a bottom plate 118. The top plate 114 is thermally connected to a heating element 112. The top plate 114 and the bottom plate 118 form a coolant passage 116 therebetween. The top plate 114 and the bottom plate 118 are joined together by crimping the plates 114 and 118 near the middle of the side wall of the heat sink 110, and by braze-bonding the crimped section 120.

A fin 122 is provided in the passage 116 such that the fin 122 connects the top plate 114 to the bottom plate 118. The fin 122 thus provided allows for an increase in a contact area between the heat sink 110 and the coolant that flows through the passage 116, thereby improving heat dissipation performance.

The top plate 114 has an inflow port 124 and an outflow port 126. The coolant flows into the passage 116 through the inflow port 124 and flows out of the passage 116 through the outflow port 126. Unions 128 are fitted respectively in the inflow port 124 and in the outflow port 126. The unions 128 are connecting members that connect tube paths 130, through which the coolant flows, to the heat sink 110. Heat generated by the heating element 112 is removed by the coolant flowing through the passage 116. The coolant flowing out of the heat sink 110 is supplied to a radiator (not shown). The radiator radiates the heat outside.

Japanese Patent Application Publication No. 2006-294699 (JP-A-2006-294699) describes a heat sink that includes: a top plate and a bottom plate, in which the top plate and the bottom plate forms a coolant passage therebetween, wherein a semiconductor chip as to a heating element is mounted on an insulating substrate and a stress relaxation member, and the top plate is thermally connected the semiconductor chip through the insulating substrate and the stress relaxation member, and the heat sink dissipates heat from the semiconductor chip through the coolant.

In the heat sink 110, the inflow port 124 and the outflow port 126 are both formed on the top plate 114. Accordingly, the flow direction of the coolant abruptly changes when the coolant flows from the tube path 130 to the passage 116 and when it flows from the passage 116 to the tube path 130, resulting in an increase in pressure loss. In particular, when the outflow port 126 is formed in the top plate 114, which requires the coolant to flow upward, it exhibits a tendency of higher pressure loss. As the pressure loss increases, more power is used to drive a pump that circulates the coolant.

One conceivable methods of reducing the pressure loss is to provide the inflow port 124 and the outflow port 126 on the side wall of the heat sink 110. With this design, the flow direction of the coolant is only moderately changed when the coolant flows from the tube path 130 to the passage 116 and when it flows from the passage 116 to the tube path 130. However, the top plate 114 and the bottom plate 118 are bonded together at the middle position of the side wall of the heat sink 110. Assuming that the inflow port 124 and the outflow port 126 are provided at a location other than this bonded area of the top plate 114 and the bottom plate 118, the heat sink 110 would be larger in size. Thus, in order to provide the inflow port 124 and the outflow port 126 on the side wall of the heat sink 110 without increasing the size of the heat sink 110, the method of brazing the top plate 114 and the bottom 118 together needs to be improved.

### SUMMARY OF THE INVENTION

The present invention provides a method of brazing a heat sink having: a top plate that is thermally connected to a heating element; and a bottom plate that forms a passage of coolant with the top plate, in which while a space is secured for an inflow port and an outflow port to be provided on a side wall of the heat sink, the top plate and the bottom plate are braze-bonded together.

An aspect of the present invention is directed to a method of brazing a heat sink that includes: a top plate that is thermally connected to a heating element; and a bottom plate bonded to the top plate, wherein: a coolant passage, formed between the top plate and the bottom plate; dissipates heat from the heating element to the coolant; and formed the top plate into a shape having opposite ends that protrude in the same direction, when viewed in section, the method including fitting at least a part of the bottom plate between the protruding opposite ends of the top plate; fixing a jig to an outer periphery of the top plate in order to prevent the top plate that thermally expands from extending outward in a width direction of the top plate; and braze-bonding an inner side surface of the top plate to a side surface of the bottom plate, which faces the inner side surface of the top plate.

In accordance with the method of brazing the heat sink according to the above aspect of the present invention, the heat sink that includes: the top plate thermally connected to the heating element; and the bottom plate that forms the coolant passage with the top plate, while a space is secured for an inflow port and an outflow port to be provided on a side wall of the heat sink, the top plate and the bottom plate are braze-bonded together.

### BRIEF DESCRIPTION OF THE DRAWINGS

The foregoing and/or further objects, features and advantages of the invention will become more apparent from the following description of example embodiments with reference to the accompanying drawings, in which like numerals are used to represent like elements and wherein:

FIG. 1 illustrates the overall structure of a heat sink according to the related art;

FIG. 2 is a sectional view of the overall structure of a heat radiator, including a heat sink, according to one embodiment of the present invention;

FIG. 3 is a sectional view of the overall structure of the heat sink according to the embodiment of the present invention;

FIG. 4A is a sectional view that shows a method of brazing the heat sink according to the embodiment of the present invention;

FIG. 4B is a top view of FIG. 4A;

FIG. 5 shows the relationship between the ratio of the thickness of a top plate to the thickness of a bottom plate and the stress of an insulating substrate according to the embodiment of the present invention; and

FIG. 6 is a sectional view that shows a method of brazing a heat sink according to another embodiment of the present invention.

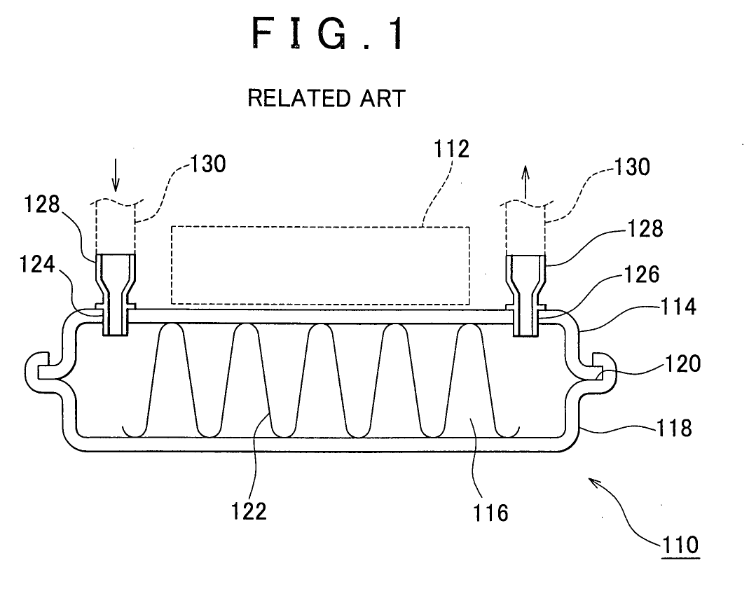

### DETAILED DESCRIPTION OF EMBODIMENTS

A method of brazing a heat sink according to one embodiment of the present invention will be described below in detail with reference to the drawings. The description of the embodiment of the present invention focuses on the method of brazing a heat sink that is used in a power module, as an example. The power module supplies electric power to a motor that drives an automobile. Application of the present invention is not limited to heat sinks that are used in automobile power modules, but also applied to any heat sink used to cool a heating element.

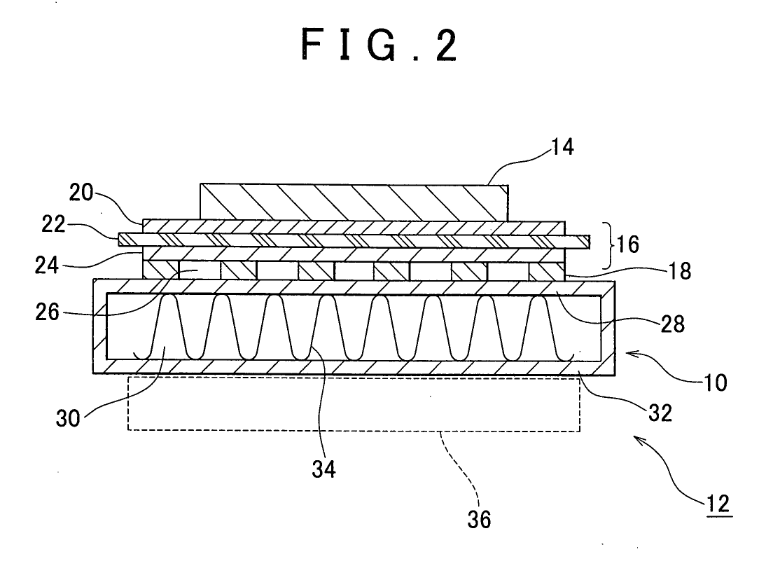

FIG. 2 is a sectional view that illustrates the overall structure of a heat radiator 12 including a heat sink 10 according to the embodiment of the present invention. The heat radiator 12 has the heat sink 10 and an insulating substrate 16. A semiconductor chip 14 is mounted on the topside of the insulating substrate 16. The heat sink 10 is provided on the underside of the insulating substrate 16 through a stress relaxation member 18 that has a stress absorbing space. The insulating substrate 16, the stress relaxation member 18, and the heat sink 10 are braze-bonded to each other.

The semiconductor chip 14 may be a switching element used for an inverter or a booster converter. The semiconductor chip 14 includes an IGBT, a power transistor, a thyristor, and so forth. The switching element generates heat when it is actuated.

The insulating substrate 16 is formed of a first aluminum layer 20, a ceramic layer 22, and a second aluminum layer 24, which are stacked one after another.

An electric circuit is formed on the first aluminum layer 20. The semiconductor chip 14 is soldered onto and electrically connected with the electric circuit. The first aluminum layer 20 is made of aluminum having suitable conductivity. However, the first layer 20 may be made of any material having suitable conductivity, such as copper. Preferably, the first aluminum layer 20 is made of high-purity aluminum, which has high electric conductivity and high malleability, and is suitable for soldering to the semiconductor chip 14.

The ceramic layer 22 is made of ceramic that has high insulation performance, high thermal conductivity, and high mechanical strength. Aluminum oxide and aluminum nitride are examples of ceramic.

The stress relaxation member 18 is braze-bonded to the second aluminum layer 24. The second aluminum layer 24 is made of aluminum having suitable thermal conductivity. However, the second layer 24 may be made of any material having suitable thermal conductivity, such as copper. Preferably, the second aluminum layer 24 is made of high-purity aluminum which has high thermal conductivity and high malleability, and which exhibits excellent wettability with respect to a molten brazing material.

The stress relaxation member 18 has a stress absorbing space. The stress absorbing space is a through hole 26 that runs through the stress relaxation member 18 in the direction the layers are stacked. The through hole 26 can be deformed to absorb the stress. The through hole 26 is slit-shaped and disposed on the stress relaxation member 18 in a staggered arrangement. The through hole 26 is not necessarily slit-shaped, but may be a polygonal hole or a circular hole. The stress relaxation member 18 is made of aluminum having suitable thermal conductivity. However, the stress relaxation member 18 may be made of any material having suitable thermal conductivity, such as copper. Preferably, the stress relaxation member 18 is made of high-purity aluminum which has high thermal conductivity and high malleability, and which exhibits excellent wettability with respect to a molten brazing material. In the description of the embodiment of the present invention, the stress absorbing space is the through hole 26 that runs through the stress relaxation member 18 in the direction that the layers are stacked. However, the present invention is not limited to this configuration. Instead of running through the stress relaxation member 18, the through hole 26 may be closed at one end.

The heat sink 10 is made of lightweight aluminum having suitable thermal conductivity. The heat sink 10 has a top plate 28 and a bottom plate 32. The top plate 28 is bonded to the stress relaxation member 18. The bottom plate 32 is bonded to the top plate 28. The top plate 28 and the bottom plate 32 form a coolant passage 30. A fin 34 is provided in the passage 30 such that the fin 34 connects the top plate 28 to the bottom plate 32. The fin 34 thus provided allows for an increase in a contact area between the heat sink 10 and the coolant that flows through the passage 30, thereby improving heat dissipation performance. The coolant flowing through the passage 30 in the heat sink 10 according to the embodiment of the present invention is long life coolant (LLC) that has anticorrosion and antifreeze properties.

Below the bottom plate 32 of the heat sink 10, an electronic device 36 is provided in contact with the bottom plate 32. A DC/DC converter and a reactor are examples of the electronic device 36. The electronic device 36 includes a heating element.

In the heat radiator 12, the heating element or the semiconductor chip 14 is thermally connected to the heat sink 10. This configuration allows heat that is generated by the semiconductor chip 14 to be efficiently dissipated through the insulating substrate 16 and through the stress relaxation member 18 to the coolant flowing through the passage 30 in the heat sink 10. Likewise, this configuration allows heat that is generated by the electronic device 36 to be efficiently dissipated to the coolant flowing through the passage 30 in the heat sink 10.

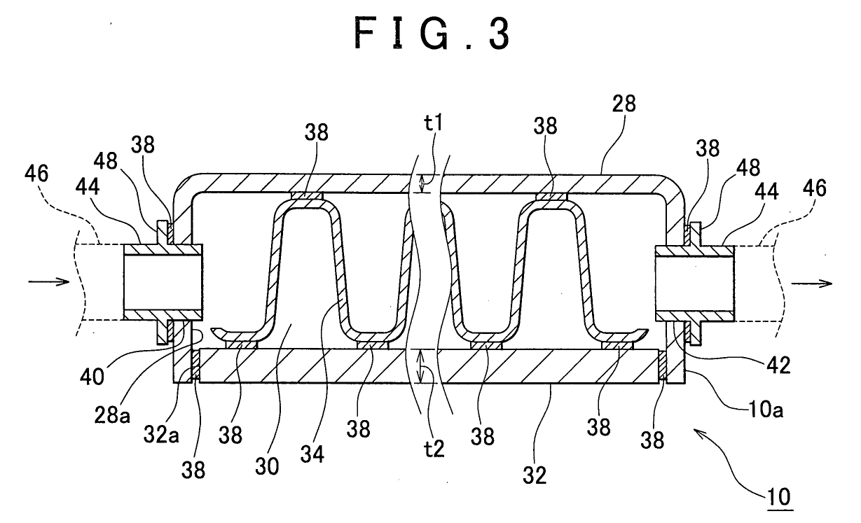

The overall structure of the heat sink 10 will be described with reference to FIG. 3. As described above, the heat sink 10 includes the top plate 28, the bottom plate 32, and the fin 34. When viewed in section, the top plate 28 is formed into a shape having opposite ends that protrude in the same direction. The bottom plate 32 is located so as to fit between the protruding ends of the top plate 28. Between the protruding ends of the top plate 28 is defined as a range of the length extending from one of the protruding opposite ends to the other. The bottom plate 32 is formed into a flat shape. The top plate 28 has an inner side surface 28a. The outer peripheral edge 32a of the bottom plate 32 faces the inner side surface 28a. The inner side surface 28a is braze bonded to the outer peripheral edge 32a. The fin 34 is braze-bonded to the top plate 28 and to the bottom plate 32. In FIG. 3, the reference numeral 38 indicates a blazed area.

An inflow port 40 and an outflow port 42 are formed in the side walls 10a of the heat sink 10. Coolant flows through the inflow port 40 and outflow port 42 into and out of the passage 30. The coolant flows through the inflow port 40 into the passage 30 and flows out of the passage 30 through the outflow port 42. A union 44 is fitted in the inflow port 40 and in the outflow port 42, respectively. The unions 44 are connecting members that connect tube paths 46, through which the coolant flows, to the heat sink 10. Each union 44 has a flange 48 that protrudes outward. The flange 48 and the side wall 10a of the heat sink 10 are braze-bonded together. The side wall 10a of the heat sink 10 corresponds to a middle part of each of the protruding opposite ends of the top plate 28, when viewed in section.

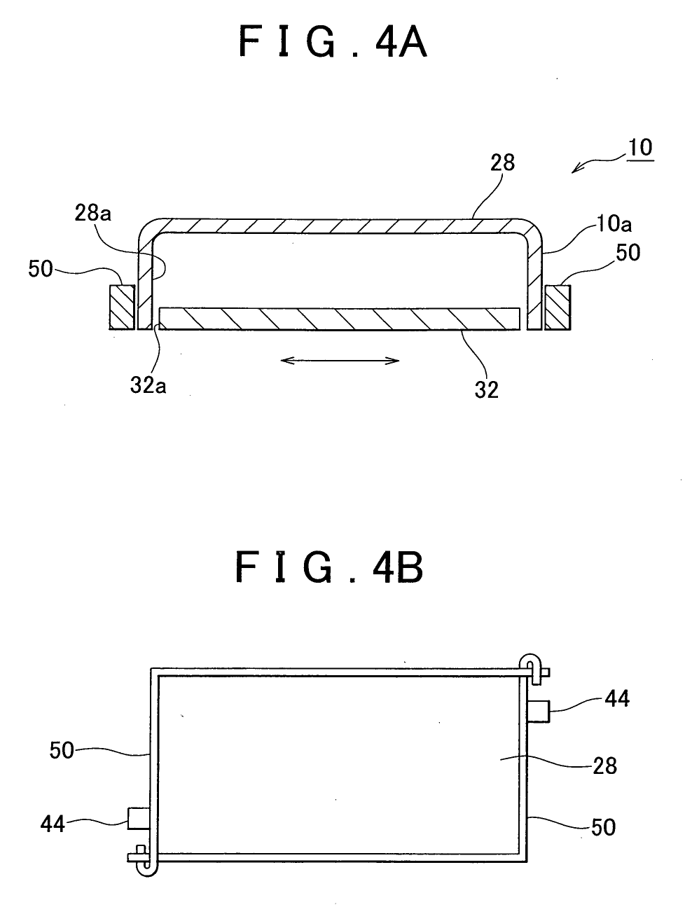

The method of brazing the heat sink 10, more specifically, the method of brazing the top plate 28 and the bottom plate 32 together will be described with reference to FIGS. 4A and 4B.

As shown in FIG. 4A, the top plate 28 is formed into a shape having the opposite ends that protrude in the same direction, when viewed in section. Then, the bottom plate 32 is fitted between the protruding ends of the top plate 28. At the same time, the bottom plate 32 is located leaving a slight clearance to between the protruding ends of the top plate 28. Then, a jig 50 is attached to the outside of the side wall 10a of the heat sink 10. More specifically, as shown in FIG. 4A, the jig 50 is attached on the outer side in the direction of between the protruding ends of the top plate 28 (in the direction shown by the arrow). As shown in FIG. 4B, the jig 50, including two separate members, is attached to the top plate 28 to fix it, such that the jig 50 is routed around the outer periphery of the top plate 28. At the same time, the unions 44 are also attached to the top plate 28.

Then, the ambient temperature is increased from the room temperature (for example 25° C.) to approximately 600° C. This causes the top plate 28 and the bottom plate 32 both made of aluminum to thermally expand. Meanwhile, the top plate 28 is fixed at its outer periphery by the jig 50. The jig 50 restricts the top plate 28 from expanding in the outwardly extending direction, that is, in the direction that is shown by the arrow in the FIG. 4A. However, the jig 50 does not restrict expansion of the bottom plate 32, so that the bottom plate 32 expands in the outwardly extending direction, that is, in the direction that is shown by the arrow in the FIG. 4A. The expansion of the bottom plate 32 allows its side surface 32a to contact the inner side surface 28a of the top plate 28. When the clearance between the side surfaces 28a and 32a is equal to or below 0.1 mm, the side surfaces 28a and 32a may be braze-bonded together. The unions 44 are then braze-bonded to the top plate 28.

As described above, the top plate 28 is formed into a shape having the opposite ends that protrude in the same direction, when viewed in section. The bottom plate 32 is fitted between the protruding ends of the top plate 28. Also, in order to prevent the top plate 28 that thermally expands from extending outward in its width direction, a jig 50 is fixed to the outer periphery of the top plate 28, before the brazing is performed. By taking advantage of the expansion of the bottom plate 32, the inner side surface 28a of the top plate 28 and the side surface 32a of the bottom plate 32 can be bonded together. In accordance with the described method of brazing the heat sink, the top plate 28 and the bottom plate 32 are bonded together not at the middle position of the side wall 10a of the heat sink 10, but at a base of the heat sink 10, specifically, at edges of the protruding opposite ends of the top plate 28. This avoids increasing the size of the heat sink 10 and ensures a space for the inflow port and the outflow port to be provided on the side wall 10a of the heat sink 10. Consequently, the coolant moderately changes its flow directions when flowing from the tube path 46 to the passage 30 and when flowing from the passage 30 to the tube path 46. Accordingly, the pressure loss decreases, and therefore, less power is required to drive the coolant circulation pump.

Returning to FIG. 3, the top plate 28 and the bottom plate 32 are relatively thin enough to ensure reduced weight and suitable thermal conductivity. The top plate 28 according to the embodiment of the present invention has thickness t1 of 0.8 mm, taking its durability into account. To be more specific, when the top plate 28 has the thickness t1 below 0.8 mm, the coolant flowing through the passage 30 corrodes and damages the top plate 28. The thickness t1 of the top plate 28 is not limited to 0.8 mm, but may be greater than 0.8 mm. As long as the top plate 28 ensures reduced weight and suitable thermal conductivity, its thickness t1 may be preset in the range of 0.8 mm to 1.2 mm.

In contrast, the bottom plate 32 according to the embodiment of the present invention has thickness t2 of 4.0 mm. The reason for setting the thickness t2 to 4.0 mm will be described below more specifically.

Generally, in the process of bonding the insulating substrate, the stress relaxation member, and the heat sink to each other, they are braze-bonded together at approximately 600° C., and then cooled. This causes thermal stress due to different thermal linear expansion coefficients between the insulating substrate and the heat sink. The thermal stress is so higher than thermal stress which is caused between the insulating substrate and the heat sink when the semiconductor chip generates heat, that the stress relaxation member cannot relax. Thus, the thermal stress may damage the insulating substrate. Therefore, the thickness t2 of the bottom plate 32 according to the embodiment of the present invention is preset at an optimum value for relaxing the thermal stress that is caused in the process of bonding the insulating substrate 16, the stress relaxation member 18, and the heat sink 10 to each other.

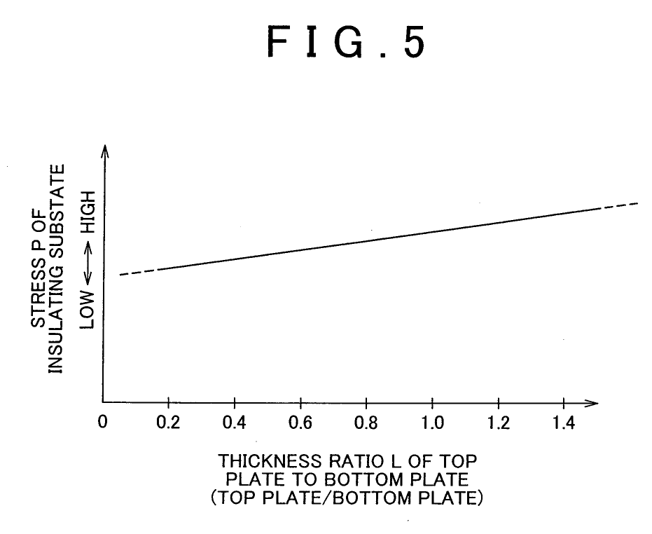

The relationship between the ratio L of the thickness of the top plate 28 to the thickness of the bottom plate 32 and the stress P of the insulating substrate 16 is described with reference to FIG. 5. The ratio L may be obtained by dividing the thickness t1 of the top plate 28 by the thickness t2 of the bottom plate 32. The stress P is induced in the insulating substrate 16 during the process of bonding the insulating substrate 16, the stress relaxation member 18, and the heat sink 10 to each other.

In an experiment, multiple heat sinks 10, each having a different ratio L, were bonded to the insulating substrate 16, the stress relaxation member 18, and the heat sink 10. The experimental results demonstrates that the stress P tends to decrease as the ratio L decreases, as shown in FIG. 5. A decrease in stress P means that the thermal stress that occurs during the bonding process is relaxed, and consequently damage to the insulating substrate 16 is prevented. In other words, as the thickness t2 of the bottom plate 32 is greater relative to the thickness t1 of the top plate 28, the stress P can decrease, thereby preventing the insulating substrate 16 from being damaged.

However, as the thickness t2 of the bottom plate 32 increases, so does its weight. This increases the weight of the heat sink 10. In addition, as the thickness t2 of the bottom plate 32 increases, the thermal conductivity also decreases. This prevents efficient dissipation of the heat generated by the electronic device 36.

Therefore, the thickness t2 of the bottom plate 32 is preset at 4.0 mm, taking relaxing the stress P as well as ensuring reduced weight and excellent thermal conductivity into account. The thickness t2 of the bottom plate 32 is not restricted to 4.0 mm. The thickness t2 may be set within a suitable range where the stress P is relaxed, and reduced weight and suitable thermal conductivity are ensured. Preferably, the thickness t2 of the bottom plate 32 is preset at a value at which the proportion between the thickness t1 of the top plate 28 and the thickness t2 of the bottom plate 32 falls within the range of 1:3 to 1:5.

According to the embodiment of the present invention, the heat sink 10 has such a simple structure that the thickness ratio between the top plate 28 and the bottom plate 32 is preset in the range of 1:3 to 1:5. This ensures reduced weight and excellent thermal conductivity of the heat sink 10, while relaxing the thermal stress that is occurs during the bonding process. The insulating substrate 16 is thus prevented from being damaged.

In the described embodiment of the present invention, the top plate 28, the bottom plate 32, and the fin 34 of the heat sink 10 are bonded together by vacuum brazing. However, the present invention is not limited to this configuration. Alternatively, the top plate 28, the bottom plate 32, and the fin 34 of the heat sink 10 may be braze-bonded using noncorrosive flux. In this case, the top plate 28 is coated with noncorrosive flux, which improves its durability against the coolant. Accordingly, the thickness t1 of the top plate 28 may be reduced below 0.8 mm to, for example, 0.4 mm. Thereby, a further reduction in weight of the heat sink 10 and improvement in thermal conductivity of the heat sink 10 are achieved.

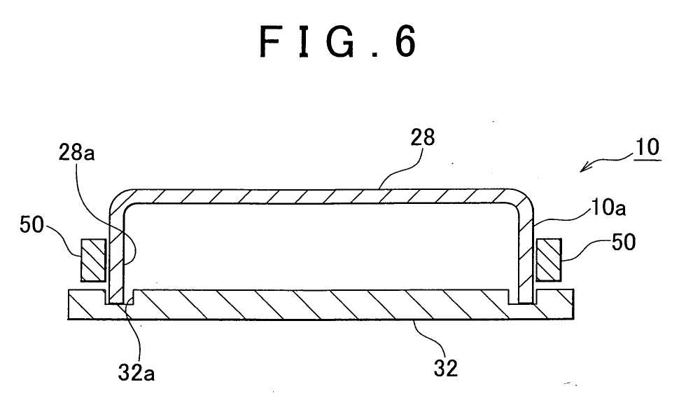

Also, in the described embodiment of the present invention, as shown in FIG. 4A, the bottom plate 32 is fitted between the protruding ends of the top plate 28 before being braze-bonded the top plate 28 and the bottom plate 32 together. However, the present invention is not limited to this configuration. At least a part of the bottom plate 32 may be fitted between the protruding ends of the top plate 28, thereby to braze-bond the top plate 28 and the bottom plate 32 together. More specifically, as shown in FIG. 6, a groove is formed on the bottom plate 32, and each protruding end of a top plate 28 is inserted in the groove. This allows at least a part of the bottom plate 32 to fit between the protruding ends of the top plate 28. Then, in order to prevent the top plate 28 that thermally expands from extending outward in its width direction, the top plate 28 is fixed at its outer periphery by a jig 50, and then the brazing is conducted. By taking advantage of the thermal expansion of the bottom plate 32, the inner side surface 28a of the top plate 28 and a side surface 32a of the bottom plate 32 are bonded together. The side surface 32a of the bottom plate 32 is defined as a face formed on the inner side than the outermost peripheral surface of the bottom plate 32.

While the invention has been described with reference to example embodiments thereof, it should be understood that the invention is not limited to the described embodiments or constructions. To the contrary, the invention is intended to cover various modifications and equivalent arrangements. In addition, while the various elements of the example embodiments are shown in various combinations and configurations other combinations and configurations, including more, less or only a single element, are also within the spirit and scope of the invention.

What is claimed is:

1. A method of brazing a heat sink that includes: a top plate thermally connected to a heating element; and a bottom plate bonded to the top plate, wherein a coolant passage, formed between the top plate and the bottom plate; dissipates heat from the heating element to the coolant; and formed the top plate into a shape having opposite ends that protrude in the same direction, when viewed in section, the method comprising
fitting at least a part of the bottom plate between the protruding opposite ends of the top plate;
fixing a jig to an outer periphery of the top plate in order to prevent the top plate that thermally expands from extending outward in a width direction of the top plate; and
braze-bonding an inner side surface of the top plate to a side surface of the bottom plate, which faces the inner side surface of the top plate.

2. The method of brazing a heat sink according to claim 1, wherein an inflow port and an outflow port, through which the coolant flows in and out of the passage, respectively, are formed on a side wall of the heat sink, and when the top plate and the bottom plate are bonded together, unions are braze-bonded respectively to the inflow port and the outflow port.

3. The method of brazing a heat sink according to claim 2, wherein the inflow port and the outflow port for the coolant are formed on a wall of the top plate at a middle part of each of the protruding opposite ends.

4. The method of brazing a heat sink according to claim 1, wherein the bottom plate is a flat plate.

5. The method of brazing a heat sink according to claim 1, wherein a ratio of the thickness of the top plate to the thickness of the bottom plate is between about 1:3 to 1:5.

6. The method of brazing a heat sink according to claim 1, wherein the side surface of the bottom plate is an outer peripheral surface of the bottom plate.

7. The method of brazing a heat sink according to claim 1, wherein:
the bottom plate has a groove, and
the side surface of the bottom plate is a surface of the groove, the surface being formed on an inner side than an outer peripheral surface of the bottom plate.

8. The method of brazing a heat sink according to claim 1, wherein a clearance between the inner side surface of the top plate and the side surface of the bottom plate, which faces the inner side surface of the top plate, is equal to or smaller than 0.1 mm when the brazing is conducted.
